(19) United States
(12) Patent Application Publication
(10) Pub. No.: US 2018/0020294 A1
(43) Pub. Date: Jan. 18, 2018

(54) METHOD FOR CHECKING THE FUNCTIONING AND/OR SEATING OF A HEARING AID

(71) Applicant: SIVANTOS PTE. LTD., SINGAPORE (SG)

(72) Inventors: SIMON HUETTINGER, ERLANGEN (DE); JUDITH PISCHEL, NUERNBERG (DE); THOMAS DICKEL, BUTTENHEIM (DE); MATTHIAS FROEHLICH, ERLANGEN (DE)

(21) Appl. No.: 15/649,685

(22) Filed: Jul. 14, 2017

(30) Foreign Application Priority Data
Jul. 14, 2016 (DE) 102016212879.5

(51) Int. Cl. H04R 25/00

(52) U.S. Cl. CPC H04R 25/30; H04R 25/70; H04R 25/505; H04R 25/558

(57) ABSTRACT

A method checks the functioning and/or seating of a hearing aid. A plurality of sounds is acoustically rendered into a hearing aid seated in an auditory canal according to a user-specific audiogram. A user-specific reaction with respect to the auditory perception of each acoustically rendered sound is detected, and the functioning and/or the seating of the hearing aid in the auditory canal are inferred on the basis of the user-specific reaction.

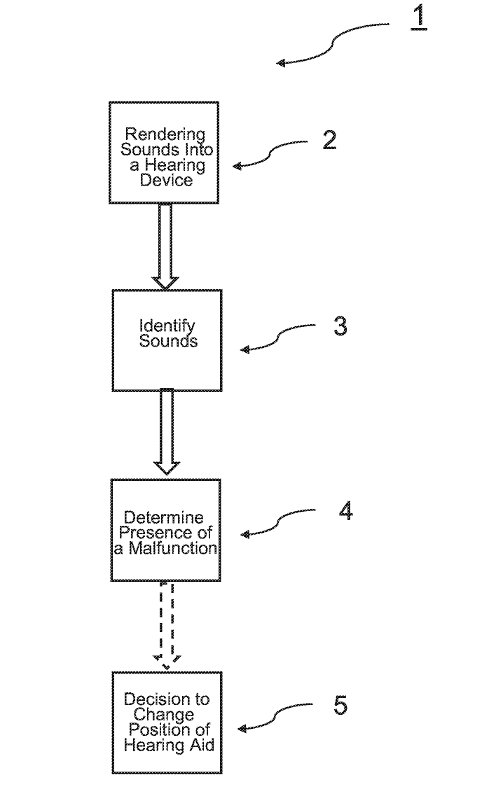

### CROSS-REFERENCE TO RELATED APPLICATION

This application claims the priority, under 35 U.S.C. §119, of German application DE 10 2016 212 879.5, filed Jul. 14, 2016; the prior application is herewith incorporated by reference in its entirety.

### BACKGROUND OF THE INVENTION

### Field of the Invention

The invention relates to a method for checking the functioning and/or seating of a hearing aid.

A plurality of persons around the world is affected by hearing loss and hearing difficulty. The reduction of one's hearing negatively affects communication and contact with other persons. Hearing aids enable their users, who have reduced hearing, to have a largely normal auditory perception again.

A malfunction or an incorrect seat of a hearing aid is frequently the reason why a hearing aid is declined, since the expected improvement in hearing does not occur and resultant malfunctions are perceived as being a nuisance. Therefore, a verification of the hearing aid functionality and of the correct seat of a hearing aid is enormously significant in order to ensure the desired improvement in the hearing and, in particular, to ensure a largely normal auditory perception. Such checks are usually carried out regularly by a hearing care professional in order to identify and correct the incorrect usage or the incorrect seat of the hearing aid. It is desirable, however, for the hearing aid wearer to be able to check the seat or to check for a possible malfunction him/herself when he/she notices irregularities in his/her auditory perception, for example, and would like to determine and eliminate the cause of the fault condition.

Such a check of the proper function of the hearing aid is not readily possible, however. Proper operation and the inspection of hearing-aid functions are not easy tasks for older persons or children, in particular. In the event that hearing aid settings are improperly changed by the hearing aid wearer him/herself or by parents, relatives, or healthcare personnel, it is possible that the person's hearing will become worse, even if the only issue is that the hearing aid is not correctly seated.

Published, non-prosecuted German patent application DE 10 2013 225 760 A1, corresponding to U.S. patent publication No. 2015/0172829, describes a hearing aid having seat detection and describes a corresponding method which detects whether a hearing aid system or a hearing aid component is correctly seated in an ear. For this purpose, according to DE 10 2013 225 760 A1, an acoustic test signal is output by an output device and is received by a receiver. The received test signal is compared with fixedly preset reference values of reference criteria in order to obtain a status signal. By means of the status signal, it can then be established whether the hearing aid system is correctly seated.

German patent DE 10 2005 034 380 B3, corresponding to U.S. Pat. No. 7,856,107, describes a hearing aid having automatic determination of its seat in the ear, and a corresponding method. According to DE 10 2005 034 380 B3, an acoustic measuring signal is output into the auditory canal in order to determine the correct seat of the hearing aid or of the hearing aid component in an auditory canal. The measurement signal influenced in the auditory canal by the hearing aid or the hearing aid component is recorded and is compared with a reference signal. Information regarding the seat of the hearing aid is determined on the basis of the comparison. This information is transmitted to an external unit along with a status report. An objective piece of information regarding the seat of the hearing aid can therefore be obtained, in particular in the case of treating a child.

### SUMMARY OF THE INVENTION

One problem addressed by the invention is that of providing a method which makes it possible to easily and quickly check the function and/or seat of a hearing aid.

This problem is solved according to the invention by a method for checking the function and/or seat of a hearing aid. A number of sounds is acoustically rendered into a hearing aid seated in an auditory canal according to a user-specific audiogram. A user-specific reaction with respect to the auditory perception of the or each acoustically rendered sound is detected, and the functioning and/or the seating of the hearing aid in the auditory canal is inferred on the basis of the user-specific reaction.

In a first step, the invention is directed to the fact that, in the case of diminished auditory perception, the hearing aid wearer is not readily able to determine the reason therefor. The hearing aid wearer cannot assess whether the cause of reduced or diminished auditory perception is merely an incorrect seat, whether the function of the hearing aid is impaired, for example, due to defective components or a dead battery, or whether his/her own hearing has worsened, and so hearing aid settings should be changed.

A check must therefore be carried out by a hearing care professional, which requires additional effort, which is an unwanted additional burden for older persons in particular. It is therefore possible that a case of poor auditory perception is initially put up with by the hearing aid wearer and his/her daily life is correspondingly affected.

The invention solves this problem with the aid of a method in which findings regarding the functioning and/or the seating of the particular hearing aid can be made on the basis of the reaction of a hearing aid wearer. For this purpose, a number of sounds is acoustically rendered into a hearing aid seated in an auditory canal in accordance with a user-specific audiogram. A user-specific reaction with respect to the auditory perception of the or each acoustically rendered sound is then detected. In particular, it is detected, for example, whether the user has heard the or each acoustically rendered sound. The functioning and/or the seating of the hearing aid in the auditory canal is then inferred on the basis of these results, i.e., on the basis of the user-specific reaction.

By means of such a method, a hearing aid wearer is enabled to carry out a check of his/her hearing aid on his/her own, or with the aid of friends, relatives, or healthcare personnel. There is no need to visit a hearing care professional for this purpose.

The number of sounds is acoustically rendered according to the particular user-specific audiogram. An audiogram describes the subjective faculty to hear sounds, i.e., the frequency-dependent auditory sensitivity of a person. The audiogram is user-specific and illustrates the faculty of hearing by depicting the hearing threshold at different frequencies. The hearing threshold indicates, in this case, how weak a sound is allowed to become before it can no longer be heard by the person in question or, conversely, at which loudness level a sound having a specific frequency is perceived.

In the case of a check, if the or each sound acoustically rendered into the hearing aid is clearly perceived by a hearing aid wearer, there is no malfunction of the hearing aid. The seat in the ear canal is also correct in this case. In particular, for this purpose, the sound having a corresponding frequency is acoustically rendered with a loudness level that is above the specific hearing threshold given by the audiogram which is stored in the hearing aid, for example.

In particular, a faulty function and/or a faulty seat of the hearing aid in the auditory canal is inferred on the basis of the user-specific reaction. A faulty function and/or a faulty seat of the hearing aid are/is obvious—assuming that the hearing aid wearer's hearing has not worsened, in principle—when the sound or sounds that actually should have been heard due to the personal audiogram that is present are perceived as being faint or are not perceived at all. The hearing aid wearer then receives notification regarding whether it is merely necessary to change the seat of the hearing aid or whether the function of the hearing aid is adversely affected in such a way that a check by a hearing care professional is necessary and that the hearing aid may need to be repaired.

Particularly preferably, the user-specific reaction with respect to the auditory perception is detected by a computer, in particular by a mobile communication device. A mobile communication device is understood to be, in this case, any type of communication device that allows for mobile communication, in particular wireless voice or data communication. Laptops, tablets, and smart phones, for example, are suitable for use as mobile communication device for checking the functioning and/or seating of a hearing aid.

The use of a smart phone is preferred in particular in this case. For this purpose, a smart phone is utilized, for example, with an appropriate program, i.e., an app, which is capable of detecting the user-specific reaction and of subsequently evaluating said reaction. The reaction of the user is preferably detected via recognition of voice input. Alternatively preferably, the reaction is a manual input by the hearing aid wearer or by a second person who is assisting the hearing aid wearer and who is recognized and is allocated or evaluated.

It is particularly advantageous when the user-specific reaction with respect to the auditory perception is automatically detected. Such an automatic detection preferably takes place by a voice recognition algorithm which automatically recognizes the spoken language and then makes this spoken language accessible to data processing, preferably likewise automatically. The speech is advantageously recorded via a microphone on the particular communication device utilized for detecting the user-specific reaction.

The functioning and/or the seating of the hearing aid in the auditory canal is inferred on the basis of the user-specific reaction, preferably automatically in this case as well. It is therefore automatically determined whether the hearing aid functions flawlessly and/or is correctly seated in the auditory canal, or whether any changes need to be made to the seat and/or the hearing aid settings. The output of the results, which are determined on the basis of the user-specific reaction, preferably likewise takes place automatically. The hearing aid wearer is automatically notified in this case whether there is a problem and, if so, what the problem is, and how this problem can be eliminated.

Particularly preferably, the results are output via the communication device. In this way, a message visualizing the results of the check can appear on the display of a communication device such as, for example, a smart phone, which notifies the user whether he/she must “reposition the hearing aid”, whether a “soiling” is present, or whether there is “damage to hearing aid components” that adversely affects the function. Alternatively preferably to a visualized output, the output takes place as voice output. In particular, the output takes place by means of a special signal which is acoustically rendered into the hearing aid.

Particularly preferably, the results of the hearing aid check are automatically transmitted to a hearing care professional. The hearing care professional can store the results in the corresponding patient file and utilize the results, if necessary, for purposes of optimization and/or consultation during the next adjustment meeting.

Individual sounds and/or sequences of sounds can be acoustically rendered into the hearing aid in order to check the functioning and/or the seating. In this case, all sounds are matched to the user-specific audiogram and account for the user-specific hearing threshold both with respect to the loudness of the or each sound and with respect to the frequency.

Preferably, a sequence of sounds containing sounds having different frequencies is acoustically rendered into the hearing aid in order to check the functioning and/or the seating. The sound frequency is the number of oscillations of a sound wave per second and describes the pitch. The pitch of a sound in this case is not given by one single fixed frequency, but rather is psychoacoustically perceived and will be the result of an interplay of various different frequencies. Further preferably, sounds having different frequencies are acoustically rendered into the hearing aid at different loudness levels. The loudness of the acoustically rendered sounds is preferably adapted to a user-specific, individual hearing threshold in a frequency-dependent manner in this case.

Advantageously, the or each sound is acoustically rendered at a loudness level below a user-specific discomfort level. The discomfort level refers to the sound pressure of an acoustic signal at which the hearing is perceived to be uncomfortably loud. The discomfort level is advantageously part of the user-specific audiogram and is therefore taken into account accordingly in the check of the functioning and/or the seating. The level values in each case depend on the loudness and the frequency of a perceived sound.

Advantageously, the or each sound is acoustically rendered at a loudness level above the user-specific, individual hearing threshold. In this way, it is ensured that the or each sound would be audible by the hearing aid wearer, in principle. Particularly preferably, a number of sounds between the personal hearing threshold and the discomfort threshold, i.e., the range of the most comfortable loudness, is therefore acoustically rendered. The or each sound is preferably acoustically rendered at a loudness level in a range between 10 dB and 50 dB above the user-specific, individual hearing threshold.

Further preferably, the frequency of a sound having a fixed loudness is varied. In this way, it is possible to detect the loudness level at which a sound having a certain frequency is detected. Acoustically rendering a tone having a varying frequency in the sense of a “wobble tone” is advantageous for hearing aid wearers who suffer from so-called sudden deafness or tinnitus, since such a sound is not perceived as unpleasant.

The frequency of the or each sound lies advantageously in a range between 500 Hz and 1500 Hz. The frequency of the or each sound is adapted, in this case, to the extent of hearing loss by the hearing aid wearer, in particular. In addition, the age of the hearing aid wearer is taken into account, since the hearing threshold shifts toward high frequencies with increasing age.

Further preferably, the loudness of a sound having a fixed frequency is varied in order to check the functioning and/or the seating of the hearing aid. In this case it is possible to determine which frequencies the hearing aid wearer perceives at a certain loudness level.

After the hearing aid wearer has received the results of the check of his/her hearing aid, he/she has the option to possibly make necessary changes with respect to the positioning of the hearing aid or to clean the hearing aid. It may be necessary to change setting parameters. Alternatively, the hearing aid wearer can schedule an appointment with a hearing care professional.

After the seat within the auditory canal has been changed and/or after the hearing aid has been cleaned or repaired, the method can be carried out again in order to ensure that the hearing aid is now optimally seated and no more malfunctions are evident.

Other features which are considered as characteristic for the invention are set forth in the appended claims.

Although the invention is illustrated and described herein as embodied in a method for checking the functioning and/or seating of a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a flow chart describing a method of checking a hearing aid according to the invention.

### DETAILED DESCRIPTION OF THE INVENTION

Turning now to the single FIGURE of the drawing in detail, there is shown a schematic method sequence 1 for carrying out a check of the functioning and/or the seating of a hearing aid. First, a sequence of five sounds is acoustically rendered into a hearing aid inserted into an auditory canal of a hearing aid wearer according to a user-specific audiogram. In this case, the acoustically rendered sounds are acoustically rendered below the discomfort level and above the user-specific hearing threshold. In the present case, the sounds have a fixed loudness of 30 dB above the user-specific, individual hearing threshold and are acoustically rendered individually, one after the other, in a frequency range of 700 Hz to 900 Hz in increments of 50 Hz (step 2).

The hearing aid wearer then names the sounds he/she was able to hear. The detection of his/her user-specific perception of each individual sound takes place by means of a voice recognition program of a smart phone, which automatically records the reaction (step 3).

On the basis of this user-specific data, it is then determined whether a malfunction of the hearing aid is present and whether the hearing aid is correctly seated in the auditory canal. By way of example, the conclusions which can be drawn on the basis of the perceived sounds, i.e., on the basis of the user-specific reaction, are mentioned in the following (step 4).

If the hearing aid wearer hears all five acoustically rendered sounds, the hearing aid has been correctly inserted and functions flawlessly. If only three or four sounds are heard, it is inferred that the seat is faulty. If only one or two sounds are perceptible, it can be inferred that components of the hearing aid are soiled. If the hearing aid wearer is unable to perceive any sound at all, it can be inferred that components of the hearing aid are defective and/or a battery is dead. In this case, it is assumed that the audiogram that is used is current and that the faculty of hearing of the hearing aid wearer has not become substantially worse in this regard.

The particular result is then automatically output to the hearing aid wearer, which takes place via the display of the utilized smart phone in this case. On the basis of this result, a decision can now be made as to whether it is merely necessary to change the position of the hearing aid in the auditory canal or whether a visit to a hearing care professional is necessary (step 5).

Alternatively to a sequence of sounds, it is also possible, of course, to acoustically render a sound having a fixed frequency with a variable loudness. The loudness is increased in this case until the hearing aid wearer confirms the perception thereof.

The following is a summary list of reference numerals and the corresponding structure used in the above description of the invention:
1 method sequence
2 first step
3 second step
4 third step
5 fourth step

1. A method for checking a functioning and/or a seating of a hearing aid, which comprises the steps of:
acoustically rendering a number of sounds into the hearing aid seated in an auditory canal according to a user-specific audiogram;
detecting a user-specific reaction with respect to an auditory perception of each acoustically rendered sound; and
inferring the functioning and/or the seating of the hearing aid in the auditory canal on a basis of the user-specific reaction.

2. The method according to claim 1, which further comprises inferring a faulty functioning and/or a faulty seating of the hearing aid in the auditory canal on a basis of the user-specific reaction.

3. The method according to claim 1, which further comprises detecting the user-specific reaction with respect to the auditory perception by means of a computer or a mobile communication device.

4. The method according to claim 1, which further comprises automatically detecting the user-specific reaction with respect to the auditory perception.

5. The method according to claim 1, which further comprises automatically inferring the functioning and/or the seating of the hearing aid in the auditory canal on a basis of the user-specific reaction.

6. The method according to claim 1, which further comprises acoustically rendering a sequence of the sounds containing sounds having different frequencies into the hearing device.

7. The method according to claim 1, which further comprises acoustically rendering the sounds having different frequencies into the hearing device at different loudness levels.

8. The method according to claim 1, which further comprises adapting a loudness of acoustically rendered sounds to a user-specific, individual hearing threshold in a frequency-dependent manner.

9. The method according to claim 1, which further comprises acoustically rendering each of the sounds at a loudness level below a user-specific discomfort level.

10. The method according to claim 1, which further comprises acoustically rendering each of the sounds at a loudness level above a user-specific, individual hearing threshold.

11. The method according to claim 1, which further comprises acoustically rendering each of the sounds at a loudness level in a range between 10 dB and 50 dB above a user-specific, individual hearing threshold.

12. The method according to claim 1, which further comprises varying a frequency of each of the sounds having a fixed loudness level.

13. The method according to claim 1, wherein a frequency of each of the sounds lies in a range between 500 Hz and 1500 Hz.

14. The method according to claim 1, which further comprises varying a loudness of the sound having a fixed frequency.
